(19) United States
(12) Patent Application Publication
(10) Pub. No.: US 2009/0262649 A1
(43) Pub. Date: Oct. 22, 2009

(54) BUS GUARDIAN WITH IMPROVED CHANNEL MONITORING

(75) Inventors: Manfred Zinke, Aachen (DE); Markus Baumeister, Munich (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/092,855

(22) PCT Filed: Nov. 6, 2006
(86) PCT No.: PCT/IB06/54122

§ 371 Date: Oct. 23, 2008

Related U.S. Application Data
(60) Provisional application No. 60/735,950, filed on Nov. 10, 2005.

(51) Int. Cl. H04L 12/26

(52) U.S. Cl. 370/242

(57) ABSTRACT

A device and method for detection of timing errors or failures of a communication controller (24) by a decentralized bus guardian (26) is provided. In a node (20) on a communication network (38), a communication controller (24), a bus guardian (26) and a bus driver (34) operate to receive and transmit information in a designated communication time slot on a communication medium (38). The bus guardian monitors activity on a communication medium and determines if it appears that the communications from other specific nodes on the communication medium are placing information on the communication medium within their designated communication time slots (54). If two or more of the communications from the other specific nodes are operating outside of there designated time slots, then the bus guardian determines that its own related communication controller has a timing failure.

The present invention relates generally to electronic communication on an automotive communication network. More specifically, embodiments of the present invention are related to communication networks for data found on a ground transportation vehicle and that provides an efficient method and system for detecting timing failures of a communication controller in such a communication network.

In recent years there has been a significant increase in the amount of electronics introduced into a automobiles, trucks, and other ground transportation vehicles. This trend is expected to continue as car companies introduce further advances in safety, reliability and comfort. The introduction of advanced control systems that combine multiple sensors, actuators and electronic control units are placing demands on the communication and data bus technology found in existing automobiles. The new demands are not completely supported by existing communication protocols.

Additional requirements for future in-car control applications include the combination of higher data rates, deterministic behavior, and the support of fault tolerance. Flexibility of both data bandwidth and the ability for system expansion are key attributes contribute to increased functionality and on-board diagnostics of an in-car data bus protocol and its related devices.

Availability, reliability and data bandwidth are the key for targeted applications such as power train, chassis and body control applications. These applications must be supported within automotive environment.

To ensure the reliability of highly advanced safety systems, fault-tolerant, time-triggered communication protocols will be obligatory. There are two such protocols currently being developed for the automotive environment. One is the FlexRay protocol and the other is the time-triggered protocol (TTP). Each protocol has its own set of merits and shortcomings.

Both the FlexRay protocol and the TTP are being developed with the requirements for an advanced communication system for automotive applications in mind. The FlexRay protocol specifically is being developed to define a communication system that targets the future of in-car control applications.

The FlexRay protocol provides flexibility by combining scalable static and dynamic message transmission and by incorporating advantages of synchronous and asynchronous protocols.

Both the FlexRay protocol and the Time Triggered Protocol (TTP) are integrated communication protocols for hard real-time fault-tolerant distributed systems. They provide hard real-time message delivery with minimal jitter. Different fault-tolerance strategies are supported. Each protocol attempts to guarantee that no single failure of any part of the communication system could lead to a disrupture of communication. They each provide some sort of distributed fault-tolerant clock synchronization. Each protocol also incorporates various mechanisms for error detection, recovery, and re-integration of communication nodes. The protocol has been designed for highest data efficiency and minimal protocol overhead.

TTP and Flexray are based on time as its underlying driving force, i.e., all activities of a system are carried out in response to the passage of certain points in time. It is therefore necessary that all nodes in the system have a common notion of time. This common notion of time is provided by both communication protocols, which are based on fault-tolerant clock synchronization. The current TTP silicon controller implementation provides a synchronized clock with 1 μs tick duration. It is therefore possible for TTP to carry out globally synchronized actions or to implement distributed control loops with minimal jitter.

Both TTP and FlexRay are based on the TDMA (time division multiple access) bus access strategy. The TDMA bus access strategy is based on the principle that the individual communication controllers on the bus have time slots allocated where exactly one communication controller is allowed to send information on the bus. It is thus possible to predict the latency of all messages on the bus. Furthermore, since the messages are sent at an “a-priori” pre-determined point in time the latency jitter is minimized. As stated above, the clock synchronization of FlexRay is based on a TDMA principle. Based on its local clock, each node knows when to expect messages sent by other nodes. By comparing the arrival time of specifically-marked regular messages with the expected arrival time, the node synchronizes its clock to the global time. Thus, clock synchronization is achieved without sending any overhead messages.

The schedules of the distributed communication controllers TTP or FlexRay rely on a common global clock. This global clock is achieved by a distributed clock synchronization algorithm, which applies clock correction terms to the local clocks at the communication controllers, resulting in a corrected time base represented by a macrotick (MT). A MT is defined as an interval in time derived from the cluster-wide clock synchronization algorithm. The MT represents the smallest granularity unit of the global time.

A FlexRay bus guardian has an a-priori knowledge of the transmission times of the node it is in and restricts transmission attempts of its node's communication controller to only the configured transmission times (time slots). If the bus guardian detects an illegal transmission attempt due to a mismatch between the schedules stored in the node's communication controller and the bus guardian, the bus guardian signals an error condition to the host and inhibits any further transmission attempts by its node. The bus guardian may also mitigate illegal transmission attempts.

In such systems, the bus guardian timing must also be synchronized to the virtual global time. Specifically, for FlexRay systems an approach has been chosen that relies on continuous synchronization of the bus guardian to the timing of the communication controller in its own node and on detection of timing failures by other techniques such as the use of watch dog timers. Although this approach provides detection of most timing failures related to the communication controller, it can miss a few timing failures, because of the close timing relation between the communication controller and the decentralized bus guardian.

Presently, decentralized bus guardians of TTP and FlexRay devices cannot and do not monitor activity at the communication medium (except in a single case during an optional test of the bus guardian wherein during a dedicated part of the schedule a communication controller may transmit even thought its bus guardian disables the transmission. If the bus guardian detects activity during this special part of the schedule, it will indicate to the host that it is not able to prevent illegal transmissions from its controller, i.e. dormant fault of the node) and detect if activity from other nodes is misaligned with respect to its own schedule or timing. Such bus guardians also cannot decode received messages, which would allow performance of a clock synchronization to the global clock in the same way as a communication controller. Thus, in addition to its basic functionality, a decentralized bus guardian should also monitor selected or predetermined communication slots in order to detect if transmissions from another node in the automotive communication network are misaligned or whether its own communication controller has a timing failure.

### BRIEF SUMMARY OF THE INVENTION

Embodiments of the present invention provide a node on a communication network, in an automobile or otherwise, that comprises a communication controller, a decentralized bus guardian and a bus driver. An exemplary node is on or connected to a communication medium in an automobile, truck, industrial machine, manufacturing facility or a derivation thereof. The bus driver communicates bidirectionally with the communication medium. The communication controller is responsible for implementing the proper communication protocol by the node on the communication medium. According to its predetermined transmission schedule, the communication controller provides data transmissions via the bus driver to the communication medium. The decentralized bus guardian includes schedule information related to its assigned communication slot that its node can use on the communication medium. The bus guardian also includes schedule information about two or more other predetermined or specific nodes on the communication medium (or bus). The information about other predetermined or specific nodes may include their timing, scheduling and/or slot assignments. The bus guardian also has channel monitoring circuitry and/or software that monitors and obtains monitored information about the timing, scheduling, and/or slot usage of the two or more other predetermined or specific nodes. The bus guardian compares its schedule information about the two or more specific nodes with the obtained monitored information. Based on the comparison, the bus guardian determines whether the communication controller in its node is having a timing failure. Generally, the communication controller is having a timing failure if two or more of the monitored nodes appear to be communicating during time periods that are not within their designated communication slots (i.e. communicating during inter-slot gaps or outside of their designated communication slots). If the bus guardian determines that the communication controller is having a timing failure, then the bus guardian will disable transmissions from its node.

The above summary of the invention is not intended to represent each embodiment or every aspect of the present invention.

A more complete understanding of the method and apparatus of the present invention may be obtained by reference to the following Detailed Description when taken in conjunction with the accompanying Drawings wherein:

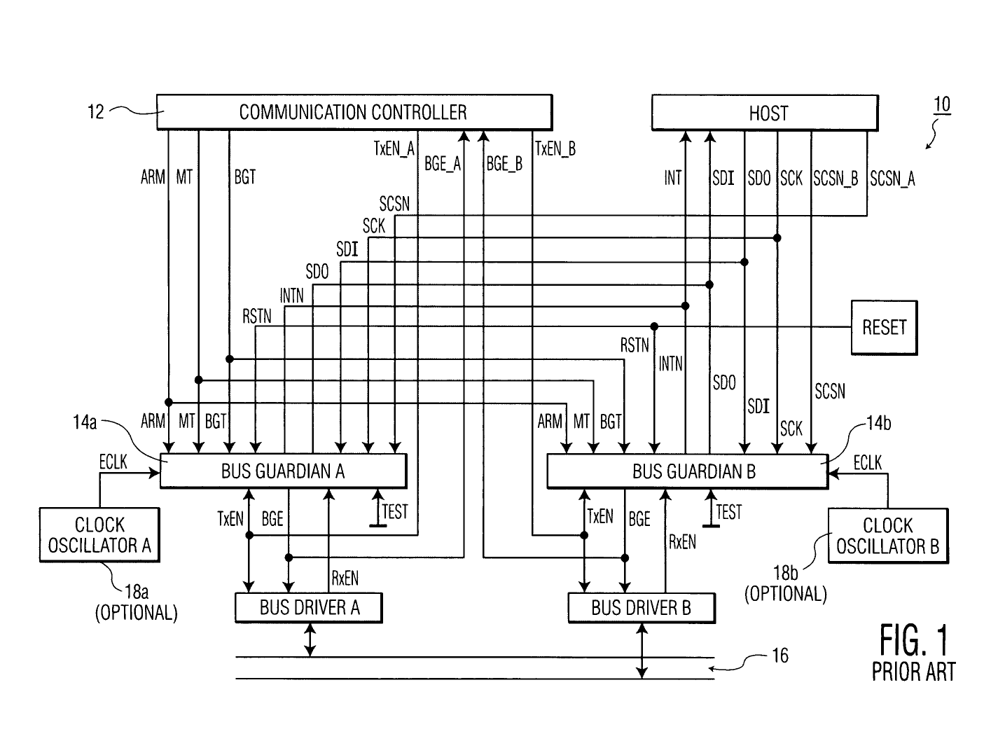

FIG. 1 is a block diagram of a FlexRay dual-channel node;

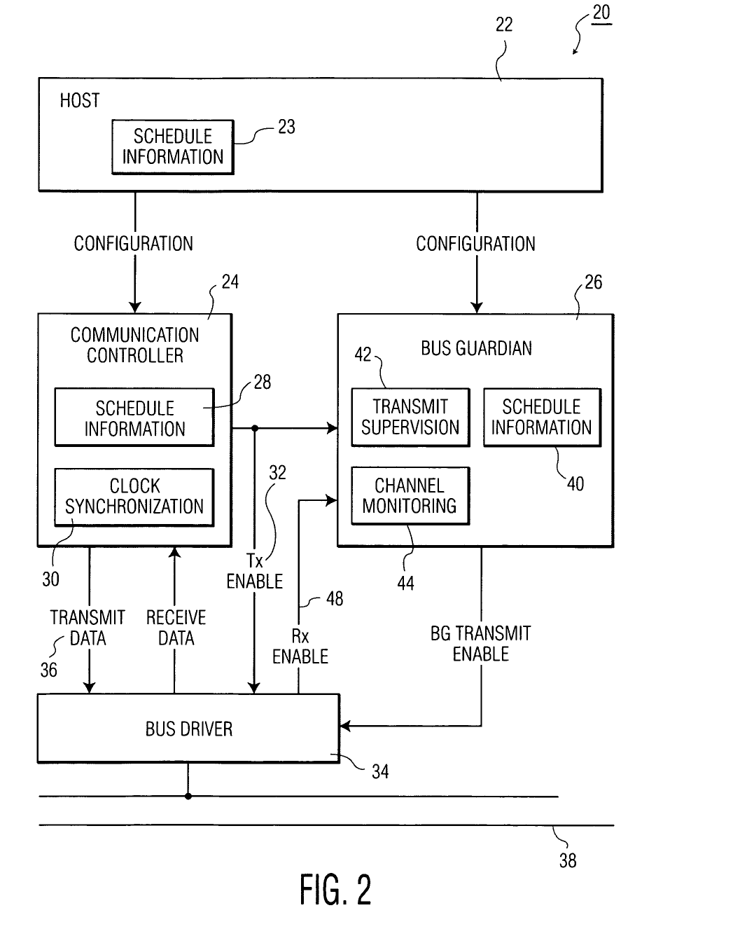

FIG. 2 is a block diagram of an exemplary node in accordance with an embodiment of the present invention; and

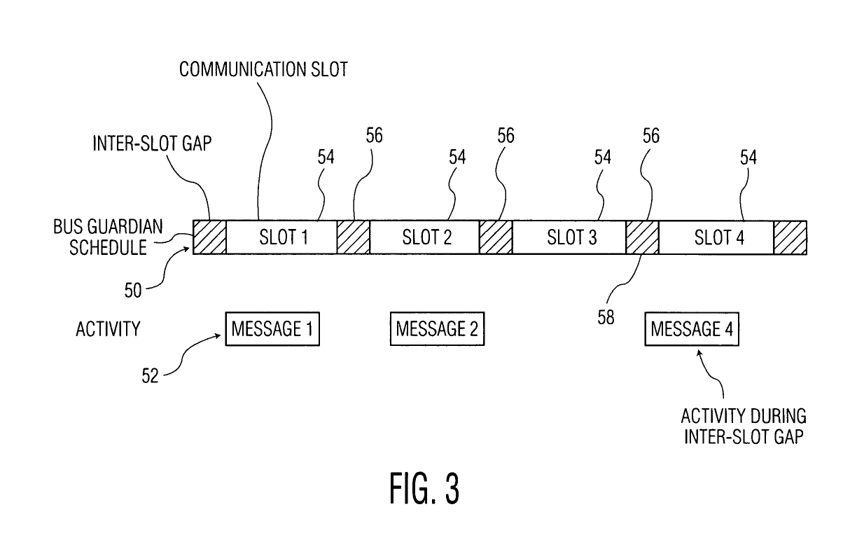

FIG. 3 is an example of a bus guardian schedule.

### DETAILED DESCRIPTION OF THE EXEMPLARY EMBODIMENTS OF THE INVENTION

Presently, dependable automotive communication networks typically rely on time-triggered communication protocols like the Time Triggered Communication Protocol TTP /C (TTP) or the FlexRay protocol. Such protocols are generally based on broadcasting messages according to a pre-determined TDMA scheme. After configuration of the network, each node in the network only has ‘a-priori knowledge’ of its own transmission times within the communication schedule and only transmits messages when its designated transmission time slot arrives. Without additional error detection, a faulty node could transmit at any time. By transmitting at times other than the faulty node's designated transmission time it could disturb the communication of other non-faulty nodes in the network. This type of failure is known as a “babbling idiot failure”. A well-known technique for avoiding a babbling-idiot type of failure is to add a bus guardian circuit between a communication controller circuit and the communication medium. Each bus guardian supervises the transmissions of its node and enables transmit access to a communication medium (i.e. a communication bus) only at the node's pre-determined transmission time slot or slots.

Referring to FIG. 1, a block diagram of a FlexRay dual-channel node 10 is depicted. The FlexRay approach of using a decentralized bus guardian as part of a node is composed of two independent units, the communication controller 12, which is responsible for transmission and reception of messages, and a bus guardian 14a and 14b, which supervises the transmissions of the communication controller and enables transmit access to the communication medium 16 only at the pre-determined transmission times.

Protection against arbitrary timing failure of the communication controller 12 can be provided by a bus guardian 14a,b only if the timing of the bus guardian(s) is/are independent from the timing of the supervised communication controller 12. If full timing independency cannot be achieved, other means are provided by the bus guardian 14a,b in order to detect timing failures of the supervised communication controller.

Existing solutions for a decentralized bus guardian 14a,b propose to achieve timing independency by using, for example, independent crystal oscillators 18a,b for the communication controller 12 and the decentralized bus guardian(s) 14a,b, respectively. This kind of solution does not allow cost-effective node implementation and is not applicable if the timing of a communication controller 12 relies on a distributed clock synchronization algorithm. Moreover, other present day existing mechanisms may violate the independency in the time domain, even if independent crystal oscillators 18a,b are used. One example of a mechanism that violates the independency of the time domain is the synchronization of the bus guardian schedule to the communication controller schedule by means of a so-called ARM-trigger signal. An ARM-trigger signal is provided by the communication controller 12 to indicate the cycle start to the bus guardian(s) 14a,b. But, if the communication controller has faulty timing, the timing of an ARM-trigger signal will most likely be misaligned with respect to the global schedule. As a result, the bus guardian(s) 14a,b are not be able to detect the failure and would not be able to protect the network from misaligned transmissions of the bus guardian's node 10.

FlexRay communication controllers synchronize their local timing to a virtual global clock by means of a distributed clock synchronization algorithm. A decentralized bus guardian 14a,b for FlexRay nodes rely on continuous synchronization of the bus guardian timing to the timing of the communication controller 12 and on supervision of the clock signals of the communication controller 12 by means of watchdogs and clock fail detectors. This solution does detect most, but not all timing failures of the supervised communication controller 12.

Therefore this FlexRay approach is not sufficient for dependable communication networks that rely on the protection of a bus guardian against any kind of arbitrary timing failure of a communication controller.

Embodiments of the present invention provide a cost-efficient method and device that detects timing failures of a communication controller with a decentralized bus guardian that also can provide full independence of the communication controller's and bus guardian's timing.

Furthermore, embodiments of the present invention add capabilities to the bus guardian that allow it to monitor activity on the communication medium and to compare the detected reception times (periods of time with activity at the communication medium) of messages from other nodes with the bus guardian's own communication schedule. Embodiments of the invention may compare the reception times of specific messages that always must be present in an operating communication system. An exemplary bus guardian may be pre-configured with a-priori knowledge about the communication slots, in which the specific messages from other nodes are sent. For example, in present operational FlexRay communication systems at least startup messages from two startup nodes must be present. These FlexRay startup messages can be re-used by an exemplary bus guardian in accordance with an embodiment of the present invention, in order to compare their reception times with the known communication schedule. The known communication schedule or a subset thereof may be stored in an exemplary bus guardian.

Referring now to FIG. 2, there is a block diagram of an exemplary node 20 in accordance with an embodiment of the present invention. The exemplary node 20 comprises a communication controller 24, a decentralized bus guardian 26, and a bus driver 34. Although a single-channel node is depicted, it is understood that a dual-channel or multi-channel node could also be created using embodiments of the present invention. A node is a logical entity connected to the network that is capable of sending and/or receiving frames. A frame is a structure used by the communication system to exchange information within the system. An exemplary frame may consist of a header segment, a payload segment, and a trailer segment. The payload segment is usually used to convey application data. A host 22 contains schedule information 23. A host 22 is generally the part of an electronic control unit (ECU) where the application software is executed. The host 22 provides configuration information to both the communication controller 24 and the bus guardian 26. The configuration information provided to the communication controller 24 and the configuration information that is provided to the bus guardian 26 are representations of the same communication schedule, but may be composed of different schedule elements.

The communication controller 24 stores schedule information 28 and has clock synchronization circuitry 30 for synchronizing with the distributed clock. The communication controller 24 also provides, among other signals, a TxEnable signal 32 to the bus driver 34, which designates the communication controller's intention to transmit.

An exemplary bus guardian 26 stores schedule information 40 and includes transmit supervision circuitry 42 and channel monitoring circuitry 44. It is understood that the transmit supervision circuitry 42 and/or the channel monitoring circuitry 44 may be performed by software within an exemplary bus guardian 26 or node 20.

The bus guardian schedule 40 includes information related to communication slot times that may be used for the transmission of messages. The bus guardian schedule 40 also includes information related to so-called “inter-slot gaps”, which separate and are between the communication slots. By appropriate configuration the inter-slot gap times define parts of the schedule that must not be used for transmission. A slot (a communication slot) is an interval of time during which access to a communication channel is granted exclusively to a specific node for the transmission of a frame with a frame ID corresponding to the slot. In addition, the communication slots and the transmission times of all the nodes connected to the communication medium 38 in the system are configured such that all messages sent with correct timing will be received within the communication slots of receiving nodes 20 connected to the communication medium 38. If all nodes are synchronized to the global schedule, none of the nodes should receive messages during the inter-slot gaps, i.e., within the inter-slop gaps the communication medium should be idle.

An exemplary bus guardian 26 that incorporates circuitry that monitors activity 44 at the communication medium can detect the reception of messages from other nodes (not specifically shown). The channel monitoring circuitry 44 compares detected reception slot times with its own communication schedule information 40. As such, the bus guardian 26 can detect whether any received messages are not aligned to the schedule information 40. The bus guardian 26 receives and monitors an activity signal, called RxEN 46. RxEn is provided by the bus driver 34 and indicates if activity is detected at the communication medium 38 or if the communication medium 38 is idle. The RxEN signal from the bus driver may, in some embodiments, be used only for monitoring purposes. An exemplary bus guardian's channel monitoring function is to observe the timing of the messages on the communication medium with respect to its own schedule and timing information and detects misalignments or timing of information on the communication medium. With this information the bus guardian detects whether the timing misalignments or failures are being caused by its related supervised communication controller 24 or by a timing failure from another node on the communication medium 38.

FIG. 3 shows an example of a bus guardian schedule 50 and the observed activity 52 by an exemplary bus guardian 26. The communication slots (slot 1, slot 2, slot 3, slot 4) 54 are separated by inter-slot gaps 56. Each node on the automobile's communication bus is scheduled to provide messages on the communication medium 38 during a predetermined communication slot 54.

The observed activity 52 is caused by transmissions from other nodes. While messages 1 and 2 are aligned within the bus guardian schedule, message 4 causes activity during the inter-slot gap 58 found between slot 3 and slot 4. Activity during the inter-slot gap 58 is interpreted by the bus guardian 26 that there is a mismatch between the bus guardian's own schedule 40 and the schedule of another node (not specifically shown).

By monitoring activity at the communication medium 16 and comparing the monitored activity with its own stored schedule information, a prior art bus guardian 14a,b can detect scheduling mismatches, but cannot distinguish between timing failures of the communication controller 12 in its own node 10 and timing failures at other nodes (not specifically shown). The ability to make a distinction between a timing failure of the communication controller 24 and a timing failure of another node is accomplished when an exemplary node 20, or better yet, if the exemplary bus guardian 26 has a-priori knowledge about the configured transmission slots of the other nodes on the communication medium 38. In some embodiments of the invention a node or bus guardian has a-priori knowledge of scheduled or the configuration of all the transmission slots of the nodes connected to the communication medium, but in many target applications of the invention this is not an acceptable solution. In various automotive communication networks, the timing and configuration of transmission slots for the nodes are not readily available for storage into each node or bus guardian.

Thus, other embodiments of the invention provide a node 20 or bus guardian 26 with a-priori knowledge of (storage of timing and/or the configuration of) specific communication slots. The a-priori knowledge of specific communication slots are used by the bus guardian 26 for monitoring and detection of timing failures. The a-priori knowledge of specific communication slots may be of communication slots that are always spaced by a predetermined amount of time or that are specific or predetermined communication slots that are a subset of the assigned communication slots of other nodes that must always transmit in these specific communication slots. The subset of other nodes may comprise nodes that are always present in an operational communication system. For example, the subset of nodes may only transmit on specific communication slots that contain messages used for communication startup or perhaps for distributed clock synchronization in the system.

In the case of an improved FlexRay communication system, which utilizes or incorporates an embodiment of the present invention, specific messages are sent by the so-called coldstart nodes in order to perform the communication startup. In a typical FlexRay cluster, three nodes are configured as coldstart nodes and each of these nodes transmits startup messages within pre-configured or specific communication slots, called startup slots. At least two fault-free coldstart nodes are necessary for a FlexRay cluster to start up. An exemplary bus guardian 26 would be configured in a FlexRay communication system with a-priori knowledge of these startup slots. The bus guardian 26 monitors and supervises the timing of received messages within the specific startup slots and the inter-slot gaps that are adjacent to the specific startup slots.

If the bus guardian 26 detects that messages are received within at least two different ones of these specific communication slots and activity is indicated by the bus driver 34 during at least one of the inter-slot gaps adjacent to each of the specific communication slots, then the bus guardian's channel monitor 44 can determine that the communication controller 24 of its own node 20 has a timing failure because it is statistically unlikely that two other nodes will have a timing failure at the same time. After determining that its own communication controller 24 has a timing failure, the bus guardian 26 will disable transmissions from its related communication controller 26 and report an error to the host 22.

If activity during an inter-slot gap adjacent to only one of the startup slots (or other specific or predetermined slots) is detected, this could be a timing failure of the startup node (or node for which other specific or predetermined slot is assigned) that is configured to send startup messages (or other specific or predetermined message for that slot assignment) during this startup slot. In this situation, the bus guardian will not disable transmissions from its own node 20, but may instead communicate a warning signal to the host 22 indicating that a timing mismatch was detected.

The proposed exemplary embodiments may imply a configuration constraint regarding the assignment of a transmission slot to a node. That is, if multiple transmission slots are assigned to a single node, then only one or none of the multiple transmission slots may be configured to be adjacent to one of the startup slots (or other specific slot) depending on the kind of timing errors that are to be detected.

Many variations and embodiments of the above-described invention and method are possible. Although only certain embodiments of the invention and method have been illustrated in the accompanying drawings and described in the foregoing Detailed Description, it will be understood that the invention is not limited to the embodiments disclosed, but is capable of additional rearrangements, modifications and substitutions without departing from the invention as set forth and defined by the following claims. Accordingly, it should be understood that the scope of the present invention encompasses all such arrangements and is solely limited by the claims as follows:

1. An device comprising a node, said node adapted to be connected to a communication network, said node comprising:
a bus driver, in electronic communication with said communication network;
a communication controller for providing data transmissions to said bus driver;
and a decentralized bus guardian in electronic communication with said communication controller and said bus driver, said decentralized bus guardian comprises:
schedule information about a first communication slot and a second communication slot;
channel monitoring means that monitors said first communication slot and said second communication slot on said communication network;
said decentralized bus guardian compares an arrival time of said monitored first communication slot and said second communication slot from another node with said schedule information and then determines whether said communication controller has a timing failure.

2. The device of claim 1, wherein said communication network is at least one of a FlexRay communication network and a TTP communication network.

3. The device of claim 1, wherein said communication network is an automotive communication network.

4. The device of claim 1, wherein said decentralized bus guardian disables transmissions from said communication controller to said bus driver when said decentralized bus guardian determines that said communication controller has a timing failure.

5. The device of claim 1, wherein said decentralized bus guardian disables transmissions from said bus driver to said communication network when said decentralized bus guardian determines that said communication controller has a timing failure.

6. The device of claim 1, wherein said node is a multi-channel node and wherein said decentralized bus guardian disables transmissions to a plurality of channels of said multi-channel node when said decentralized bus guardian determines that said communication controller has a timing failure.

7. The device of claim 1, wherein said bus guardian determines that said communication controller has a timing failure when said timing of said monitored first communication slot and said second communication slot are determined to coincide with a scheduled first inter-slot gap and a second inter-slot gap respectively.

8. A method of a detecting timing failures of a communication controller comprising:
monitoring activity of at least two specific communication slots on a communication medium;
comparing said monitored activity of said at least two specific communication slots with a schedule for said at least two specific communication slots;
determining that said communication controller has a timing failure if said monitored activity of said at least two specific communication slots are active outside of said schedule for said at least two specific communication slots.

9. The method of detecting timing failures of claim 8, wherein said method is used in a time triggered communication protocol.

10. The method of detecting timing failures of claim 8, further comprising disabling transmissions from said communication controller.

11. The method of detecting timing failures of claim 8, further comprising determining that a specific node has a timing malfunction if said monitored activity of only one of said at least two specific communication slots is outside of said schedule for the one of said at least two specific communication slots.

12. A bus guardian in a node, said bus guardian comprising;
schedule information;
and means for determining whether a communication controller said node has a timing failure.

13. The bus guardian of claim 12, wherein said bus guardian further comprises means for disabling transmissions from said communication controller if said means for determining determines that said communication controller has a timing failure.
